(19) United States
(12) Patent Application Publication
(10) Pub. No.: US 2025/0102101 A1
(43) Pub. Date: Mar. 27, 2025

(54) METHOD FOR PROTECTING BURIED METAL AND CONCRETE STRUCTURES FROM BACTERIA-INDUCED CORROSION

(71) Applicant: Concrete Sealants, Inc, Tipp City, OH (US)

(72) Inventors: David L. Melampy, Tipp City, OH (US); Van R. Foster, Tipp City, OH (US); Howard E. Wingert, Tipp City, OH (US)

(21) Appl. No.: 18/971,465

(22) Filed: Dec. 6, 2024

Related U.S. Application Data
(63) Continuation-in-part of application No. 17/983,031, filed on Nov. 8, 2022.

(51) Int. Cl. F16L 58/10; B29C 48/00; B29C 48/08; B29K 23/00; B29K 105/00; B29K 509/00

(52) U.S. Cl. CPC F16L 58/1063; B29C 48/022; B29C 48/08; B29K 2023/08; B29K 2023/22; B29K 2105/0011; B29K 2105/0088; B29K 2509/00

(57) ABSTRACT

A system and method for protecting metal and concrete structures from bacteria-induced corrosion, wherein the method includes creating a viscoelastic, self-healing wrapping material configured to encapsulate a metal structure or a concrete structure by combining a thermoplastic blend, at least one filler, at least one paraffinic oil, and at least one biocide formulated to be effective against aerobic and anaerobic bacteria, wherein the anaerobic bacteria includes sulfate-reducing bacteria; wrapping an exterior surface of a metal structure or a concrete structure with the viscoelastic, self-healing wrapping material; and placing the wrapped metal structure or concrete structure in an operational environment, wherein the viscoelastic, self-healing wrapping material is operative to prevent or greatly reduce corrosion of the metal structure or concrete structure caused by aerobic and anaerobic bacteria occurring or located in the operational environment.

### CROSS-REFERENCE TO RELATED APPLICATIONS

This patent application is a continuation-in-part of U.S. patent application Ser. No. 17/983,031 filed on Nov. 8, 2022, and entitled “Biocidal Wrapping Material”, the disclosure of which is hereby incorporated by reference herein in its entirety and made part of the present U.S. utility patent application for all purposes.

### BACKGROUND

The disclosed inventive subject matter relates in general to systems, devices, compositions, and methods for sealing and protecting underground pipes and pipelines, and more specifically to an elastomeric biocidal compound or material for wrapping buried pipes and other structures and preventing or at least dramatically reducing any corrosive effect of anaerobic bacteria present in the soil in which the pipes or other structures are buried.

Deterioration of buried metal pipes due to corrosive soil environments is a major problem worldwide. Sudden bursting of pipes and the significant losses that are a consequence thereof have been observed and reported in many countries, thus the problem is widely known and recognized. Failure of buried pipeline systems used for water, sewage, oil, and gas due to corrosion is a significant concern because these failures reduce the overall service life of such pipelines. Because these pipelines are buried underground, inspection and maintenance are very difficult in most locations. The high frequency of observed pipe failures indicates both a lack of understanding and an inaccuracy of current methods used for predicting failure of buried pipes, and although comprehensive research related to the corrosion failure of cast iron pipes has been conducted in various countries, such failures have to this point proven to be unavoidable.

Pipelines are typically designed for more than fifty years of service life, which can theoretically exceed one hundred years; however, most if not all pipelines are known to fail before achieving this service life. Age, long periods of service, damage to protective coatings internally and/or externally, improper repair and maintenance all shorten the service life of buried pipelines. The occurrence of failures is often sudden and without any warning, and because of the widespread use of buried pipelines, pipeline failure has been recognized as a global issue having severe socio-economic implications. The situation only worsens when such failures reoccur, which is frequently the case. Accordingly, a complete understanding of the factors causing external corrosion of pipes in soils is necessary, as is the development of methods and/or processes for mitigating the effects of these factors.

Numerous soil factors that cause external corrosion of buried pipes have been identified by extensive field and laboratory studies. These factors include pH, moisture content, soil type, resistivity, the presence of anaerobic bacteria, temperature, exposure duration, and differential aeration. Of particular importance is microbiologically influenced corrosion caused by sulfate-reducing bacteria and other microorganisms. Microbiologically influenced corrosion is defined as the change in the corrosion behavior of a material/metal in the presence of microorganisms. Certain bacteria are known to attach to a metal surface and form a biofilm, which degrades the metal surface by changing its physical and chemical characteristics due to the biochemical activities associated with bacterial metabolism, growth and reproduction.

Microbiologically influenced corrosion is known to be a cause of significant economic loss to the maritime, oil and gas, power generation and water distribution industries. Microbiologically influenced corrosion caused by sulfate-reducing bacteria has been well reported in the scientific literature. Sulfate-reducing bacteria are anaerobic bacteria that can be found in oxygen-deficient saturated soils, with a pH from 6-8, containing sulfate ions, organic compounds and minerals, and they grow in soils at a temperature of 20-30° C. Anaerobic bacteria have been reported to increase the corrosion process and convert non-corrosive soil to a very aggressive environment by generating hydrogen sulfide (see, for example: Factors influencing corrosion of metal pipes in soil, Environmental Chemistry Letters (2018) 16:861-879 and A Study of Microbial Influenced Corrosion in Oil and Gas Industry; Conference Paper, July 2012: https://www.researchgate.net/publication/279528726. Desulfovibrio vulgaris and Desulfovibrio ferrophilus IS5 are examples of sulfate-reducing bacteria that are known to be involved in the corrosion process. (see, for example: Effect of selected biocides on microbiologically influenced corrosion caused by Desulfovibrio ferrophilus IS5, Nature: Scientific Reports (2018) 8:16620).

Various products have been developed to provide corrosion protection to metal pipes, including epoxy paints and external pipe wraps. However, despite the use of these products, once buried, iron-based materials are corroded by not only pure physicochemical reactions but also metabolic activities of microorganisms including anaerobic bacteria that have direct access to the metal pipes. Accordingly, there is an ongoing need for protective material for use with metal pipes that provides both a protective physical barrier and that also provides protection against corrosion caused by microorganisms found in the environment surrounding the pipes.

### SUMMARY

The following provides a summary of certain example implementations of the disclosed inventive subject matter. This summary is not an extensive overview and is not intended to identify key or critical aspects or elements of the disclosed inventive subject matter or to delineate its scope. However, it is to be understood that the use of indefinite articles in the language used to describe and claim the disclosed inventive subject matter is not intended in any way to limit the described inventive subject matter. Rather the use of “a” or “an” should be interpreted to mean “at least one” or “one or more”.

One example implementation of the disclosed technology provides a method for protecting metal and concrete structures from bacteria-induced corrosion, the method comprising creating a viscoelastic, self-healing wrapping material configured to encapsulate a metal structure or a concrete structure by combining a thermoplastic blend, at least one filler, at least one paraffinic oil, and at least one biocide formulated to be effective against aerobic and anaerobic bacteria, wherein the anaerobic bacteria includes sulfate-reducing bacteria; wrapping an exterior surface of a metal structure or a concrete structure with the viscoelastic, self-healing wrapping material; and placing the wrapped metal structure or concrete structure in an operational environment, wherein the viscoelastic, self-healing wrapping material is operative to prevent or greatly reduce corrosion of the metal structure or concrete structure caused by aerobic and anaerobic bacteria occurring or located in the operational environment.

Certain implementations of the disclosed method further comprise wrapping the metal structure or concrete structure wrapped with the viscoelastic, self-healing wrapping material with a polyethylene tape configured to improve impact resistance and support the self-healing characteristics of the viscoelastic, self-healing wrapping material. Certain implementations of the disclosed method further comprise placing a scrim between the viscoelastic, self-healing wrapping material and the polyethylene tape. Certain implementations of the disclosed method further comprise configuring the viscoelastic, self-healing wrapping material as a three-dimensional tape, wherein the three-dimensional tape is round, oval, square, rectangular, triangular, or trapezoidal in shape. In certain implementations of the disclosed method, the thermoplastic blend includes an isobutylene-isoprene copolymer, a multi-arm polymer based on ethylene/propylene, an ethylene copolymer, and a polybutene polymer. In certain implementations, at least one filler includes talc; the at least one biocide includes zinc pyrithione; the metal structure includes iron or steel pipes, flanges, or valves; and the operational environment includes partial or complete burial of the metal structure or concrete structure in soil.

Another example implementation of the disclosed technology provides a first method for creating a protective wrapping material for use with metal structures or concrete structures, the method comprising combining a thermoplastic blend, at least one filler, at least one paraffinic oil, and at least one biocide formulated to be effective against acrobic and anaerobic bacteria, wherein the anaerobic bacteria includes sulfate-reducing bacteria extruding the combined material as a viscoelastic, self-healing tape configured to be applied directly to an exterior surface of a metal structure or a concrete structure; and adding a high-tack adhesive to one side of the tape, wherein the high-tack adhesive facilitates adherence of the tape to the exterior surface of a metal structure or a concrete structure.

Certain implementations of the disclosed method further comprise configuring the viscoelastic, self-healing wrapping material as a three-dimensional tape, wherein the three-dimensional tape is round, oval, square, rectangular, triangular, or trapezoidal in shape. In certain implementations, the thermoplastic blend includes an isobutylene-isoprene copolymer, a multi-arm polymer based on ethylene/propylene, an ethylene copolymer, and a polybutene polymer. In certain implementations, at least one filler includes talc; the at least one biocide includes zinc pyrithione; and the metal structure includes iron or steel pipes, flanges, or valves. In certain implementations, at least one filler includes talc; the at least one biocide includes zinc pyrithione; the metal structure includes iron or steel pipes, flanges, or valves

Still another example implementation of the disclosed technology provides a second method for creating a protective wrapping material for use with metal structures or concrete structures, the method comprising combining a thermoplastic blend, at least one filler, at least one paraffinic oil, and at least one biocide formulated to be effective against aerobic and anaerobic bacteria, wherein the anaerobic bacteria includes sulfate-reducing bacteria; extruding the combined materials as a viscoelastic, self-healing tape wrap configured to be applied directly to the exterior of a metal structure or a concrete structure as a first layer; adding a high-tack adhesive to one side of the viscoelastic, self-healing tape, wherein the high-tack adhesive facilitates adherence of the a viscoelastic, self-healing tape to the exterior surface of a metal structure or a concrete structure; and providing a polyethylene tape as a second layer, wherein the second layer is configured to be wrapped around the first layer and is operative to improve impact resistance and support the self-healing characteristics of the first layer.

Certain implementations of the disclosed method further comprise placing a scrim between the first layer and the second layer. Certain implementations of the disclosed method further comprise configuring the viscoelastic, self-healing wrapping material as a three-dimensional tape, wherein the three-dimensional tape is round, oval, square, rectangular, triangular, or trapezoidal in shape. In certain implementations, the thermoplastic blend includes an isobutylene-isoprene copolymer, a multi-arm polymer based on ethylene/propylene, an ethylene copolymer, and a polybutene polymer. In certain implementations, at least one filler includes talc; the at least one biocide includes zinc pyrithione; the metal structure includes iron or steel pipes, flanges, or valves.

It should be appreciated that all combinations of the foregoing concepts and additional concepts discussed in greater detail below (provided such concepts are not mutually inconsistent) are contemplated as being part of the inventive subject matter disclosed herein and may be implemented to achieve the benefits as described herein. Additional features and aspects of the disclosed system, devices, and methods will become apparent to those of ordinary skill in the art upon reading and understanding the following detailed description of the example implementations. As will be appreciated by the skilled artisan, further implementations are possible without departing from the scope and spirit of what is disclosed herein. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more example implementations of the disclosed inventive subject matter and, together with the general description given above and detailed description given below, serve to explain the principles of the disclosed subject matter, and wherein:

FIG. 1 is a graph depicting the results of antimicrobial testing of the disclosed materials against D. ferrophilus IS5, wherein a ˜3 log reduction in microbial load was observed when D. ferrophilus IS5 was exposed to DM 51-001-A Coupons, and wherein a ˜3 log reduction in microbial load was observed when D. ferrophilus IS5 was exposed to DM 51-002-B Coupons.

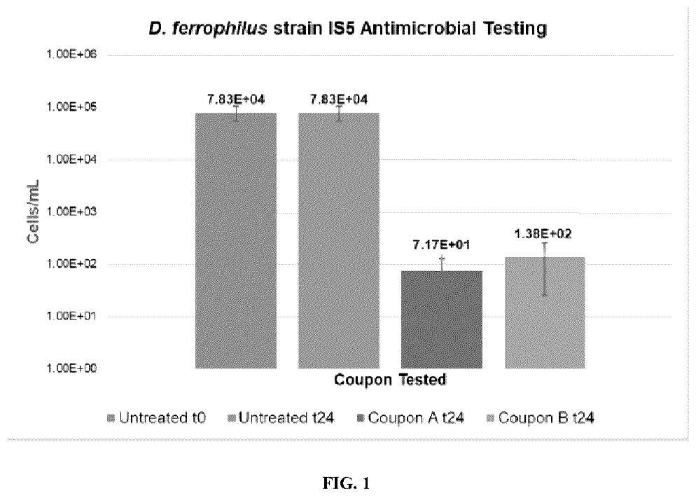

### DETAILED DESCRIPTION

Example implementations are described below. Although the following detailed description contains many specifics for the purposes of illustration, a person of ordinary skill in the art will appreciate that many variations and alterations to the following details are within the scope of the disclosed inventive subject matter. Accordingly, the following example implementations are set forth without any loss of generality to, and without imposing limitations upon, the claimed subject matter.

Sulfur is present at some level in all steel pipes due to the iron compounds used in the metal pipe manufacturing process. When moisture and sulfur are present on the exterior surface of a buried steel pipe, sulfate-reducing bacteria such as Desulfovibrio vulgaris and Desulfovibrio ferrophilus IS5 may react with the metal surface. Sulfate-reducing bacteria derive their energy from organic nutrients and are anaerobic organisms; meaning that they do not require oxygen for growth and activity. As an alternative to oxygen, these bacteria utilize sulfate with the consequent production of metal sulfides, which propagates corrosion. As described above, corrosion of iron materials in this manner is referred to as microbiologically influenced corrosion (MIC). The technology disclosed herein includes a protective pipe wrapping compound that provides both a physical barrier against moisture and physical contaminants and protection against MIC through the incorporation of one or more biocidal compounds into the wrap. These biocidal compounds inhibit the growth of microorganisms in the physical environment surrounding buried pipes and thus prevents or greatly reduces pipe corrosion that can result from the presence of sulfate-reducing bacteria and other potentially destructive organisms.

The disclosed pipe-wrapping compound is based on 100% solids elastomeric sealant technology. The biocide or biocides incorporated into this compound are specifically selected to mitigate or eliminate anaerobic bacterial attack of steel pipe, although these biocides are also effective against aerobic bacteria. Wrapping a steel pipe with the disclosed compound prevents environmental water from contacting the steel surface of the pipe. The biocidal component greatly reduces or eliminates the effects of any anaerobic bacteria that are trapped between the pipe-wrapping compound and the pipe during the pipe wrapping process, thereby preventing bacterial induced corrosion of the pipe. An example implementation of the disclosed biocidal pipe-wrapping compound appears in Table 1, below.

### EXAMPLES

TABLE 1
First Example Formulation

| | | | % by |
|---|---|---|---|
| Ingredient | Manufacturer | Category | weight |
| Butyl | Lanxess | isobutylene- | 1.65% |
| RB 301 T | Corporation | isoprene | |
| | | copolymer | |
| Kraton | Kraton | multi-arm | 0.90% |
| G-1750 | Polymers, Inc. | polymer | |
| | | based on | |
| | | ethylene/ | |
| | | propylene | |
| Rextac ® | REXtac, | ethylene | 20.30% |
| RT 2315 | LLC | copolymer | |
| | | Amorphous | |
| | | Polyalphaolefin | |
| | | (APAO) | |
| TPC 1160 | TPC Corp. | polybutene | 23.00% |
| polyisobutylene | | polymer | |
| SERICRON ® | Specialty | filler | 52.65% |
| 2M Talc | Minerals Inc. | | |
| Calpar 325 | Calumet, | paraffinic | 1.10% |
| | Inc. | base oil | |
| Micropel ZPT98 | Troy Corporation | biocide | 0.40% |

TABLE 2
Second Example Formulation

| | | | % by |
|---|---|---|---|
| Ingredient | Manufacturer | Category | weight |
| Butyl RB | Lanxess | isobutylene- | 3.0% |
| 301 T | Corporation | isoprene | |
| | | copolymer | |
| Kraton | Kraton | multi-arm | 8.0% |
| G-1750 | Polymers, Inc. | polymer | |
| | | based on | |
| | | ethylene/ | |
| | | propylene | |
| Rextac ® | REXtac, | ethylene | 12.0% |
| RT 2315 | LLC | copolymer | |
| | | Amorphous | |
| | | Polyalphaolefin | |
| | | (APAO) | |
| TPC 1160 | TPC Corp. | polybutene | 19.0% |
| polyisobutylene | | polymer | |
| SERICRON ® | Specialty | filler | 53.6% |
| 2M Talc | Minerals Inc. | | |
| Calpar 325 | Calumet, | paraffinic | 4.00% |
| | Inc. | base oil | |
| Micropel ZPT98 | Troy Corporation | biocide | 0.40% |

The example formulations disclosed in Tables 1 and 2 includes Butyl RB (rubber) 301 T, which is an isobutylene-isoprene copolymer that provides tensile strength, tear strength, and a degree of tack; Kraton G-1750, which is a multi-arm polymer based on ethylene/propylene that improves strength; RT 2315 Polyolefin, which is a polyethylene-polypropylene copolymer (amorphous polyalphaolefin); Sericron Talc, which is a filler that improves processing and reduces corrosivity; Calpar 325 which is a paraffinic oil that enhances processibility of the formulation; TPC 1160 polyisobutylene, which is a polybutene polymer; and Micropel ZPT98, which is a bactericide that contains zinc pyrithione. The combination of rubbers used in the example formulation disclosed in Tables 1 and 2 provides excellent self-healing properties to the pipe-wrapping compound. Alternate example implementations of the disclosed biocidal pipe-wrapping compound appear in Tables 3 and 4, below. In Tables 3 and 4, certain alternatives for each ingredient in each respective category are listed in the table, as are the manufacturers for each ingredient and a range of percent by weight values for each ingredient.

TABLE 3
Alternate Example Formulations I

| | | | % by |
|---|---|---|---|
| Ingredient | Manufacturer | Category | weight |
| Butyl 101-3 | Lanxess Corporation | isobutylene- | 0.50-5.0% |
| Butyl RB 301 T | Lanxess Corporation | isoprene | |
| Butyl 268 | ExxonMobil | copolymer | |
| Kraton | Kraton | multi-arm | 0.50-5.00% |
| G-1750 | Polymers, Inc. | polymer | |
| | | based on | |
| | | ethylene/ | |
| | | propylene | |
| Rextac ® | REXtac, | ethylene | 15-25% |
| RT 2315 | LLC | copolymer | |
| | | Amorphous | |
| | | Polyalphaolefin | |
| | | (APAO) | |
| TPC 1160 | TPC Corp. | polybutene | 15-30% |
| polyisobutylene | Soltex | polymer | |
| Soltex PB32 | Ineos | | |
| Indopol ® H-300 | Daelim | | |
| PB1300 | Industrial | | |
| SERICRON ® | Specialty | filler | 45-60% |
| 2M Talc | Minerals Inc. | | |
| Calpar 325 | Calumet, Inc. | paraffinic | 0.5-5.00% |
| Paralux 2401 | Chevron | oil | |
| Micropel ZPT98 | Troy Corporation | biocide | 0.05-0.6% |

TABLE 4
Alternate Example Formulations II

| | | | % by |
|---|---|---|---|
| Ingredient | Manufacturer | Category | weight |
| Butyl 101-3 | Lanxess Corporation | isobutylene- | 0.50-10.0% |
| Butyl RB 301 T | Lanxess Corporation | isoprene | |
| Butyl 268 | ExxonMobil | copolymer | |
| Kraton | Kraton | multi-arm | 0.50-15.00% |
| G-1750 | Polymers, | polymer | |
| | Inc. | based on | |
| | | ethylene/ | |
| | | propylene | |
| Rextac ® | REXtac, | ethylene | 5.0-25% |
| RT 2315 | LLC | copolymer | |
| | | Amorphous | |
| | | Polyalphaolefin | |
| | | (APAO) | |
| TPC 1160 | TPC Corp. | polybutene | 15-30% |
| polyisobutylene | Soltex | polymer | |
| Soltex PB32 | Ineos | | |
| Indopol ® H-300 | Daelim | | |
| PB1300 | Industrial | | |
| SERICRON ® | Specialty | filler | 45-60% |
| 2M Talc | Minerals Inc. | | |
| Calpar 325 | Calumet, Inc. | paraffinic | 0.5-10.00% |
| Paralux 2401 | Chevron | oil | |
| Micropel ZPT98 | Troy Corporation | biocide | 0.01-0.60% |

The disclosed pipe-wrapping compound has been laboratory tested for biocidal activity, as described below. Laboratory testing of the disclosed materials involved a product referred to as ConWrap PW or ConWrap AMS (Concrete Sealants, Inc.), which is an extruded tape with a plastic, protective coating on the exterior portion of the tape used to wrap pipes. A specific biocide was incorporated into this tape to provide antimicrobial protection and biocide challenge testing was performed against a sulfate reducing bacterium (SRB) and known contributor in microbial influenced corrosion (MIC). Antimicrobial testing was performed to evaluate the effects of the biocide Micropel ZPT98, which was incorporated into test coupons at two different concentrations (DM-51-001-A and DM-51-002-B) against Desulfovibrio ferrophilus strain IS5. Desulfovibrio vulgaris ATCC 7757 was used as an anaerobic control organism during the testing. Testing evaluated the antimicrobial resistance of 36 sample materials exposed to anaerobic bacteria. Growth and propagation of the anaerobic test organism and method development were completed and test articles were inoculated, extracted, and assayed to determine the effectiveness of the antimicrobial biocide.

Table 5 below shows the log reductions of the viable cell counts for all coupons tested. Based on the results, treated coupon A (DM 51-001-A) led to a 3-log reduction in viable cell counts for D. ferrophilus IS5 after 24 hours. Similar results were observed when the organism was exposed to treated Coupon B (DM-51-002-B). No reduction in viability was observed when the organism was exposed to the untreated coupons. Thus, both DM 51-001-A and DM 51-002-B caused a 1,000-fold decrease in the viable cell count of D. ferrophilus after a 24-hour exposure time. Note: Due to the issues in growing the anaerobic D. ferrophilus IS5 on agar plates, the Most Probable Number (MPN) method was used for detection and enumeration of viable D. ferrophilus IS5 and D. vulgaris rather than using the plate count method.

TABLE 5
Averaged MPN Results for All Test Coupons - t₂₄.

| | Coupon | Coupon | Untreated |
|---|---|---|---|
| | Conc. A | Conc. B | Coupon |
| Organism | (DM 51-001-A) | (DM 51-002-B) | (+ Control) |
| Desulfovibrio | ~3-log | ~3-log | No |
| ferrophilus IS5 | Reduction | Reduction | Reduction |
| Desulfovibrio | ~1-log | ~0.2-log | ~0.07-log |
| vulgaris | Reduction | Reduction | Reduction |
| (+Control) | | | |
| D/E Broth Only | No | No | No |
| (−Control) | Growth | Growth | Growth |

The disclosed pipe-wrapping compound or material may be configured as an extruded tape having a plastic, protective coating on an exterior portion of the tape. A scrim is typically included between the extruded sealant and the plastic, protective coating. The scrim may include polyethylene or other similar materials. The disclosed pipe-wrapping compound or material may also be configured as a three-dimensional tape. This three-dimensional tape may be manufactured in round, oval, square, rectangular, triangular, trapezoidal, or other shapes and is applied to a substrate by molding the material around and over metal pieces that include irregularly shaped sections such as, for example, a bolt-together steel flange assembly. This three-dimensional configuration provides corrosion protection in a manner similar to the extruded tape configuration applied as a pipe wrap.

The disclosed compositions are referred to as ConWrap AMS, which is a cold applied, self-healing, antimicrobial, exterior wrap system used to prevent corrosion of metal and concrete. The high-tack adhesive, peel and stick, self-healing, viscoelastic compound completely encapsulates structures, such as pipelines. A second layer, outer polyethylene tape wrap improves impact resistance and supports the self-healing characteristics of the viscoelastic wrap. ConWrap AMS provides long-term corrosion protection to exposed and buried infrastructure such as pipelines, flanges, and valves. For high temperature applications (up to 100° C.) ConWrap AMS100 may be used.

All literature and similar material cited in this application, including, but not limited to, patents, patent applications, articles, books, treatises, and web pages, regardless of the format of such literature and similar materials, are expressly incorporated by reference in their entirety. Should one or more of the incorporated references and similar materials differ from or contradict this application, including but not limited to defined terms, term usage, described techniques, or the like, this application controls.

As previously stated and as used herein, the singular forms “a,” “an,” and “the,” refer to both the singular as well as plural, unless the context clearly indicates otherwise. The term “comprising” as used herein is synonymous with “including,” “containing,” or “characterized by,” and is inclusive or open-ended and does not exclude additional, unrecited elements or method steps. Although many methods and materials similar or equivalent to those described herein can be used, particular suitable methods and materials are described herein. Unless context indicates otherwise, the recitations of numerical ranges by endpoints include all numbers subsumed within that range. Furthermore, references to “one implementation” are not intended to be interpreted as excluding the existence of additional implementations that also incorporate the recited features. Moreover, unless explicitly stated to the contrary, implementations “comprising” or “having” an element or a plurality of elements having a particular property may include additional elements whether or not they have that property.

The terms “substantially” and “about”, if or when used throughout this specification describe and account for small fluctuations, such as due to variations in processing. For example, these terms can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%, and/or 0%.

Underlined and/or italicized headings and subheadings are used for convenience only, do not limit the disclosed subject matter, and are not referred to in connection with the interpretation of the description of the disclosed subject matter. All structural and functional equivalents to the elements of the various implementations described throughout this disclosure that are known or later come to be known to those of ordinary skill in the art are expressly incorporated herein by reference and intended to be encompassed by the disclosed subject matter. Moreover, nothing disclosed herein is intended to be dedicated to the public regardless of whether such disclosure is explicitly recited in the above description.

There may be many alternate ways to implement the disclosed inventive subject matter. Various functions and elements described herein may be partitioned differently from those shown without departing from the scope of the disclosed inventive subject matter. Generic principles defined herein may be applied to other implementations. Different numbers of a given module or unit may be employed, a different type or types of a given module or unit may be employed, a given module or unit may be added, or a given module or unit may be omitted.

Regarding this disclosure, the term “a plurality of” refers to two or more than two. Unless otherwise clearly defined, orientation or positional relations indicated by terms such as “upper” and “lower” are based on the orientation or positional relations as shown in the figures, only for facilitating description of the present invention and simplifying the description, rather than indicating or implying that the referred devices or elements must be in a particular orientation or constructed or operated in the particular orientation, and therefore they should not be construed as limiting the present invention. The terms “connected”, “mounted”, “fixed”, etc. should be understood in a broad sense. For example, “connected” may be a fixed connection, a detachable connection, or an integral connection; a direct connection, or an indirect connection through an intermediate medium. For an ordinary skilled in the art, the specific meaning of the above terms in the present invention may be understood according to specific circumstances.

It should be appreciated that all combinations of the foregoing concepts and additional concepts discussed in greater detail herein (provided such concepts are not mutually inconsistent) are contemplated as being part of the disclosed inventive subject matter. In particular, all combinations of claimed subject matter appearing at the end of this disclosure are contemplated as being part of the inventive subject matter disclosed herein. While the disclosed inventive subject matter has been illustrated by the description of example implementations, and while the example implementations have been described in certain detail, there is no intention to restrict or in any way limit the scope of the appended claims to such detail. Additional advantages and modifications will readily appear to those skilled in the art. Therefore, the disclosed inventive subject matter in its broader aspects is not limited to any of the specific details, representative devices and methods, and/or illustrative examples shown and described. Accordingly, departures may be made from such details without departing from the spirit or scope of the general inventive concept.

What is claimed:

1. A method for protecting metal and concrete structures from bacteria-induced corrosion, the method comprising:
(a) creating a viscoelastic, self-healing wrapping material configured to encapsulate a metal structure or a concrete structure by combining a thermoplastic blend, at least one filler, at least one paraffinic oil, and at least one biocide formulated to be effective against aerobic and anaerobic bacteria, wherein the anaerobic bacteria includes sulfate-reducing bacteria;
(b) wrapping an exterior surface of a metal structure or a concrete structure with the viscoelastic, self-healing wrapping material; and
(c) placing the wrapped metal structure or concrete structure in an operational environment, wherein the viscoelastic, self-healing wrapping material is operative to prevent or greatly reduce corrosion of the metal structure or concrete structure caused by aerobic and anaerobic bacteria occurring or located in the operational environment.

2. The method of claim 1, further comprising wrapping the metal structure or concrete structure wrapped with the viscoelastic, self-healing wrapping material with a polyethylene tape configured to improve impact resistance and support the self-healing characteristics of the viscoelastic, self-healing wrapping material.

3. The method of claim 2, further comprising placing a scrim between the viscoelastic, self-healing wrapping material and the polyethylene tape.

4. The method of claim 1, further comprising configuring the viscoelastic, self-healing wrapping material as a three-dimensional tape, wherein the three-dimensional tape is round, oval, square, rectangular, triangular, or trapezoidal in shape.

5. The method of claim 1, wherein the thermoplastic blend includes an isobutylene-isoprene copolymer, a multi-arm polymer based on ethylene/propylene, an ethylene copolymer, and a polybutene polymer.

6. The method of claim 1, wherein the at least one filler includes talc.

7. The method of claim 1, wherein the at least one biocide includes zinc pyrithione.

8. The method of claim 1, wherein the metal structure includes iron or steel pipes, flanges, or valves.

9. The method of claim 1, wherein the operational environment includes partial or complete burial of the metal structure or concrete structure in soil.

10. A method for creating a protective wrapping material for use with metal structures or concrete structures, the method comprising:
(a) combining a thermoplastic blend, at least one filler, at least one paraffinic oil, and at least one biocide formulated to be effective against aerobic and anaerobic bacteria, wherein the anaerobic bacteria includes sulfate-reducing bacteria;
(b) extruding the combined material as a viscoelastic, self-healing tape configured to be applied directly to an exterior surface of a metal structure or a concrete structure; and
(c) adding a high-tack adhesive to one side of the tape, wherein the high-tack adhesive facilitates adherence of the tape to the exterior surface of a metal structure or a concrete structure.

11. The method of claim 10, further comprising configuring the viscoelastic, self-healing tape as a three-dimensional tape, wherein the three-dimensional tape is round, oval, square, rectangular, triangular, or trapezoidal in shape.

12. The method of claim 10, wherein the thermoplastic blend includes an isobutylene-isoprene copolymer, a multi-arm polymer based on ethylene/propylene, an ethylene copolymer, and a polybutene polymer.

13. The method of claim 10, wherein the at least one filler includes talc, and wherein the at least one biocide includes zinc pyrithione.

14. The method of claim 10, wherein the metal structure includes iron or steel pipes, flanges, or valves.

15. A method for creating a protective wrapping material for use with metal structures or concrete structures, the method comprising:
(a) combining a thermoplastic blend, at least one filler, at least one paraffinic oil, and at least one biocide formulated to be effective against aerobic and anaerobic bacteria, wherein the anaerobic bacteria includes sulfate-reducing bacteria;
(b) extruding the combined materials as a viscoelastic, self-healing tape wrap configured to be applied directly to the exterior of a metal structure or a concrete structure as a first layer;
(c) adding a high-tack adhesive to one side of the viscoelastic, self-healing tape, wherein the high-tack adhesive facilitates adherence of the a viscoelastic, self-healing tape to the exterior surface of a metal structure or a concrete structure; and
(d) providing a polyethylene tape as a second layer, wherein the second layer is configured to be wrapped around the first layer and is operative to improve impact resistance and support the self-healing characteristics of the first layer.

16. The method of claim 15, further comprising placing a scrim between the first layer and the second layer.

17. The method of claim 15, further comprising configuring the viscoelastic, self-healing tape as a three-dimensional tape, wherein the three-dimensional tape is round, oval, square, rectangular, triangular, or trapezoidal in shape.

18. The method of claim 15, wherein the thermoplastic blend includes an isobutylene-isoprene copolymer, a multi-arm polymer based on ethylene/propylene, an ethylene copolymer, and a polybutene polymer.

19. The method of claim 15, wherein the at least one filler includes talc, and wherein the at least one biocide includes zinc pyrithione.

20. The method of claim 15, wherein the metal structure includes iron or steel pipes, flanges, or valves.
